(19) United States
(12) Patent Application Publication
(10) Pub. No.: US 2008/0273548 A1
(43) Pub. Date: Nov. 6, 2008

(54) CONFIGURATION OF SERVICE GROUPS IN A CABLE NETWORK

(76) Inventors: Chrisanto de Jesus Leano, San Jose, CA (US); Yong Lu, San Jose, CA (US); Jin Zhang, Sunnyvale, CA (US); Tung-Fai Chan, Sunnyvale, CA (US); Tony Yuan-Kon Chang, Saratoga, CA (US); Alon Shlomo Bernstein, Sunnyvale, CA (US); John T. Chapman, Saratoga, CA (US)

Correspondence Address: SCHWEGMAN, LUNDBERG & WOESSNER, P.A., P.O. BOX 2938, MINNEAPOLIS, MN, 55402, US

(21) Appl. No.: 11/744,148

(22) Filed: May 3, 2007

(51) Int. Cl. H04B 3/02

(52) U.S. Cl. 370/442

(57) ABSTRACT

A method and apparatus for configuring service groups in a cable network is provided. A method may comprise identifying a primary downstream channel in a cable network and identifying a plurality of fiber nodes fed by the primary downstream channel. For each fiber node identified, the method may comprise identifying a set of downstream channels communicating with the fiber node. If duplicate sets are identified, duplicate sets of downstream channels may be eliminated and a downstream service group may be associated with each of the remaining sets of downstream channels. In an example embodiment, at least one Media Access Control (MAC) domain is automatically selected to correspond to the identified service groups.

### FIELD

The present disclosure relates generally to the field of cable technologies for a communication network. In one example embodiment, the disclosure relates to a system and method to configure service groups in a cable network.

### BACKGROUND

The Data Over Cable Service Interface Specification (DOCSIS) is an international cable modem standard that defines the communications and operations support interface requirements for data transmission over a cable system or network. In particular, DOCSIS specifies physical layer (PHY) aspects of cable modem transmissions as well as the Media Access Control (MAC) functionality used to access the cable transmission channels.

DOCSIS provides for a point to multipoint communications system in which downstream channels can service multiple cable modems through a continuous signal in the downstream direction, while TDMA burst signals are received from the cable modems in the upstream direction.

A Cable Modem Termination System (CMTS), which forms part of the headend of a cable network, has full ownership of the downstream traffic, which negates any negotiations for downstream transmissions. However, as multiple cable modems need to share access to the upstream channel, cable modems need to send requests through to the CMTS in order to be allocated a transmission time slot.

Channel bonding is a new feature that has been incorporated into DOCSIS 3.0. Channel bonding provides for the spreading of data transmissions over multiple radio frequency (RF) channels. This allows for a flexible way of increasing upstream and downstream throughput to subscribers.

### BRIEF DESCRIPTION OF DRAWINGS

The present disclosure is illustrated by way of example, and not limitation, in the figures of the accompanying drawings and in which like references indicate similar elements:

FIG. 1 shows an example of a system, in accordance with an example embodiment, to transmit data between various network devices and network endpoints in a cabling network;

FIG. 2 shows an example embodiment of various parameters that need to be specified or determined in order to deploy DOCSIS in a cable network;

FIG. 3 shows an example apparatus in the form of a Cable Modem Terminating System (CMTS), in accordance with an example embodiment, that may form part of the system of FIG. 1;

FIG. 4 shows an example of a frequency space diagram to indicate the configuration between downstream radio frequency (RF) channels and fiber nodes where the number of service groups correspond with the number of fiber nodes;

FIG. 5 shows an example of a service group table, in accordance with an example embodiment, that may be maintained in memory of the CMTS of FIG. 3;

FIG. 6 shows an example of a frequency space diagram to indicate the configuration between downstream radio frequency (RF) channels and fiber nodes where the number of service groups do not correspond with the number of fiber nodes;

FIG. 7 shows an example of a service group table, in accordance with an example embodiment, that may be maintained in memory of the CMTS of FIG. 6;

FIG. 8 shows an example of a method, in accordance with an example embodiment, for configuring service groups in a cable system; and

FIG. 9 shows a diagrammatic representation of machine in the example form of a computer system within which a set of instructions, for causing the machine to perform any one or more of the methodologies discussed herein, may be executed.

### DESCRIPTION OF EXAMPLE EMBODIMENTS

In the following description, for purposes of explanation, numerous specific details are set forth in order to provide a thorough understanding of an example embodiment of the present invention. It will be evident, however, to one skilled in the art that the present invention may be practiced without these specific details.

### OVERVIEW

A method and apparatus for configuring service groups in a cable network is provided. The method may comprise identifying a primary downstream channel in a cable network and identifying a plurality of fiber nodes fed by the primary downstream channel. For each fiber node identified, the method may comprise identifying a set of downstream channels communicating with the fiber node. If one or more duplicate sets are identified, the one or more duplicate sets of downstream channels may be eliminated and a downstream service group may then be associated with each of the remaining sets of downstream channels. In an example embodiment, at least one Media Access Control (MAC) domain is automatically selected to correspond to the identified service groups.

### EXAMPLE EMBODIMENTS

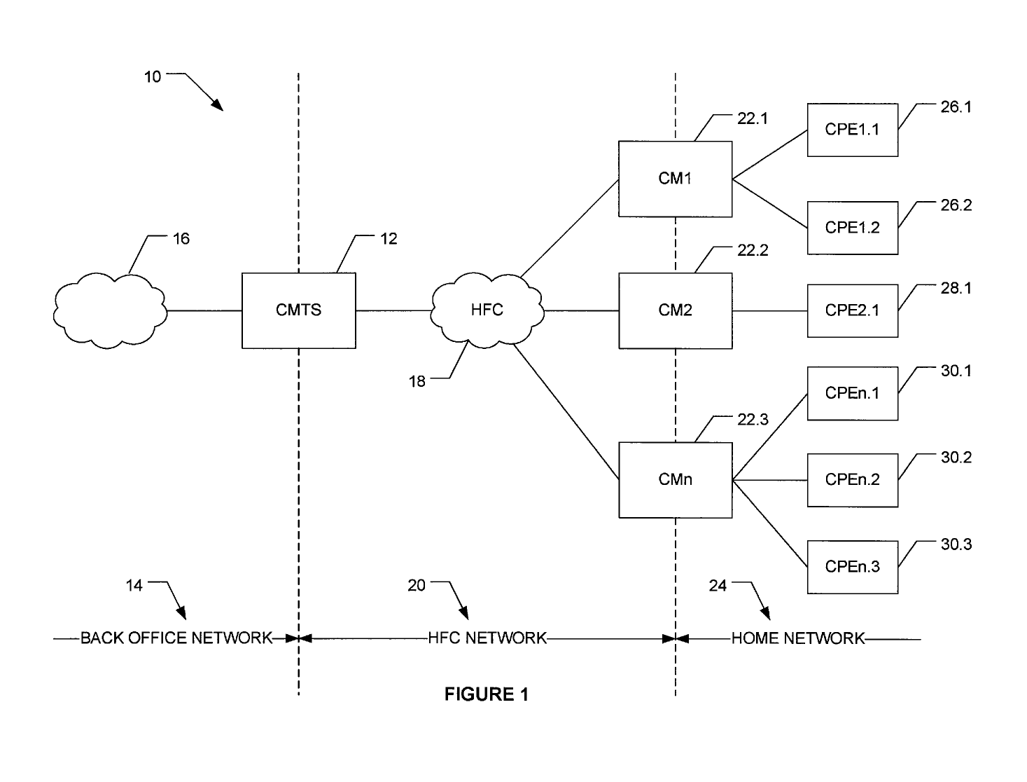

Referring to FIG. 1, reference numeral 10 generally indicates a system or network, in accordance with an example embodiment, to transmit data between various network devices and network endpoints in a cabling network. In one example embodiment, the system 10 is a DOCSIS 3.0 network.

In the example system 10, the network devices are shown to be a cable modem termination system (CMTS) 12, which may form part of a cable company's headend, and a back office network 14. The CMTS 12 is used to provide high speed data services, e.g., cable internet and/or Voice over IP (VoIP) services to subscribers, by connecting Customer Premises Equipment (CPE) of the subscribers to a wide area network, such as the Ethernet 16.

In an example embodiment, the CMTS 12 is connected to a hybrid fiber/coaxial (HFC) system 18 of a HFC network 20 of a cable company. The HFC 20 is shown, in turn, to be connected to a plurality of user network devices or CPE (e.g., via cable modems (CMs) 22.1 to 22.3). The cable modems 22.1 to 22.3 are shown by way of example to connect the cable company's HFC network 20 to respective home networks 24. Each of home networks 24 are shown by way of example to terminate in CPEs 26.1, 26.2, 28.1, 30.1, 30.2 and 30.3. It will be appreciated that any number of CMs may be provided and that CPEs may be connected to the CMs.

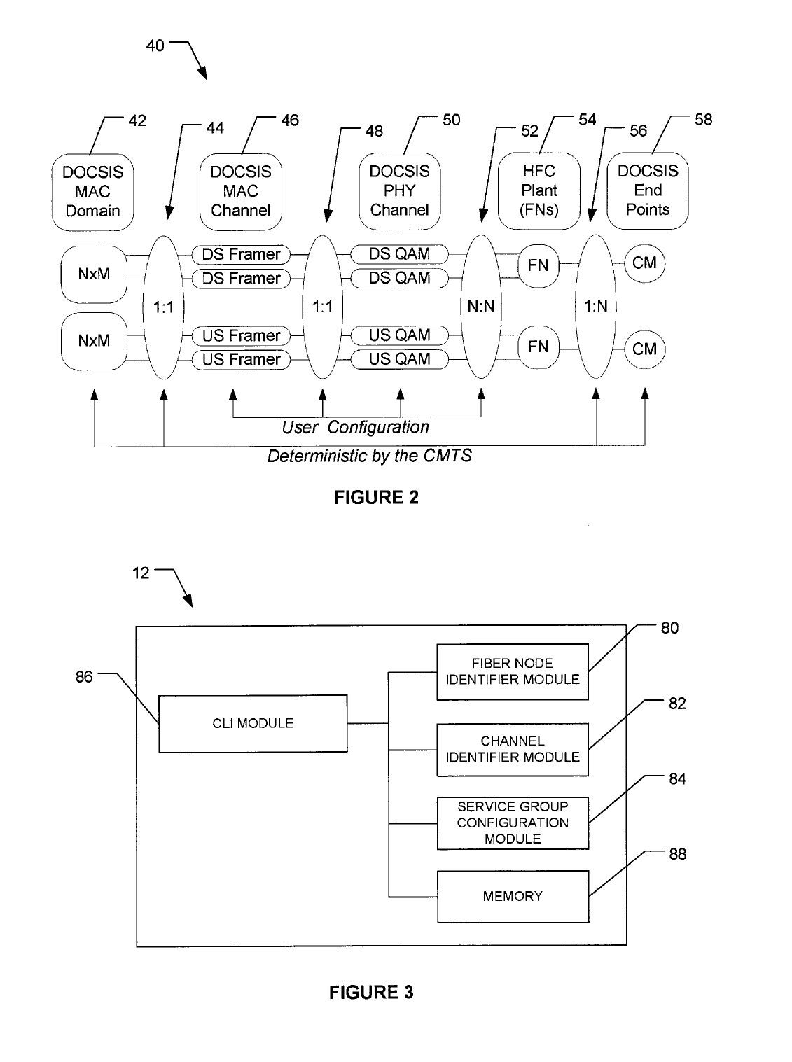

In one example embodiment, the system 10 employs the Data Over Cable Service Interface Specification (DOCSIS) to define the communications and operations support interface requirements for data transmission over the cable system or network 10. FIG. 2 shows an example embodiment of various parameters 40 that need to be specified or determined in order to employ DOCSIS, e.g., DOCSIS 3.0, in the cable network 10. These parameters define a DOCSIS MAC domain 42, a DOCSIS MAC channel 46, a DOCSIS physical (PHY) channel 50, a hybrid fiber coaxial (HFC) plant or system 54, and DOCSIS end points 58. Reference 44 generally indicates the configuration between the DOCSIS MAC domain 42 and the DOCSIS MAC channel 46, reference 48 generally indicates the configuration between the DOCSIS MAC channel 46 and the DOCSIS physical (PHY) channel 50, reference 52 generally indicates the configuration between the DOCSIS PHY channel 50 and the hybrid fiber coaxial (HFC) plant 54, and reference 56 generally indicates the configuration between the HFC plants the HFC plant 54 and the DOCSIS end points 58.

The “MAC domain” is defined in DOCSIS 3.0 as a subcomponent of the CMTS that provides data forwarding services to a set of downstream and upstream channels, while the “PHY channel” relates to layer 1 in the Open System Interconnection (OSI) architecture. This layer provides services to transmit bits or groups of bits over a transmission linked between open systems and may entail handshaking procedures. In an example embodiment, the HFC plant 50 is a broadband bidirectional shared-media transmission system that uses fiber trunks between a head-end and fiber nodes, with coaxial distribution (e.g., coaxial cables of a cable television network) from the fiber nodes to the customer network devices (e.g., the cable modems).

In an example configuration, and as shown in FIG. 2, the CMTS 12 (see FIG. 1) determines the DOCSIS MAC domain 42 and its configuration 44 with the DOCSIS MAC channel 46, as well as the configuration 56 of the DOCSIS endpoints 58 with the HFC plant 54. As further described below, the CMTS 12 may automatically configure the cable modem service groups from the network topology.

A Cable modem service group, in DOCSIS 3.0, is the complete set of downstream and upstream channels within a single CMTS that a single cable modem could potentially receive or transmit. In many HFC deployments, a cable modem service group corresponds to a single fiber node. Usually, a cable modem service group serves multiple cable modems. A downstream service group, in DOCSIS 3.0, is the complete set of downstream channels from a single CMTS that could potentially reach a single cable modem. A downstream service group corresponds to a broadband forward carrier path signal from one CMTS.

The determination of service groups is an important aspect in channel bonding, which is a new feature of DOCSIS 3.0. Channel bonding is a logical process that combines the data packets received on multiple independent channels into one higher-speed data stream. Channel bonding can be implemented independently on upstream channels and downstream channels.

In an example embodiment, the configuration 48 between the DOCSIS MAC channel 46 and the DOCSIS PHY channel 50, and the configuration 52 between the DOCSIS PHY channel 50 and the HFC plant 54 may be configured by a user (e.g., a Mobile Switching Office (MSO)). This may be done by the user specifying the DOCSIS interfaces, e.g., the layer 1, 2 and 3 parameters associated with Transport Stream Identifier (TSID), as well as the bonding channels and the fiber nodes.

In order to assign multiple downstream channels to one or more cable modems, it may be necessary to first determine what downstream channels are available for use by a particular cable modem. Various complexities may arise to determine the appropriate protocol, e.g., in some configurations, certain downstream channels used to transmit data from the CMTS to the cable modems may be split to service many remote nodes, while other downstream channels may support fewer nodes. It will thus be appreciated that the set of downstream channels which can be received by a cable modem may accordingly vary depending on the fiber node to which the cable modem is attached. MSO databases may not accurately track the exact physical location of each cable modem by MAC address, making it difficult to determine exactly what downstream channels a particular cable modem can receive.

DOCSIS 3.0 addresses this problem by means of downstream service group resolution. In this process, the cable modem uses CMTS-provided information to determine the service group to which the cable modem belongs. The necessary information is contained in a message (called an MDD message broadcast) broadcast by the CMTS at least once every two seconds on primary-cable downstream channels. Upon receiving the MDD message broadcast, the cable modem notes the channel identification (ID) of the current channel, then tunes to other frequencies of the MDD and notes what (if any) channel IDs it finds on those channels. When the cable modem's discovered channel IDs and frequencies match one and only one of the per-service-group lists of channel IDs provided in the MDD, the cable modem identifies that service group as a “match” and conveys this information to the CMTS.

In order to execute the abovementioned process, it will be appreciated that the CMTS must first be configured to associate service groups with the cable modems. An example method and apparatus to self-discover MAC domain downstream service groups is described in more detail below.

Turning to FIG. 3, an example apparatus, in accordance with an example embodiment, such as a CMTS is shown. In one example embodiment, the apparatus corresponds to the CMTS 12 of the system 10 shown in FIG. 1.

In an example embodiment, the CMTS 12 may include a fiber node identifier module 80, a channel identifier module 82, and a service group configuration module 84. The CMTS 12 may further include a Command Line Interface (CLI) module 86 and a memory 88 that may hold various tables necessary to support the functioning and/or configuration of the CMTS 12. The memory may also include instructions which, when executed, perform the methodology described herein.

The fiber node identifier module 80 may determine the physical downstream fiber node topology. In an example embodiment, the fiber node identifier module 80 may determine the topology by identifying a number of fiber nodes configured to communicate data between upstream and downstream network devices in a cable network. For example, the fiber node identifier module 80 may identify the number of fiber nodes (e.g., the fiber nodes of the HFC plant 54 of FIG. 2) configured and connected to a CMTS 12 to transmit data in a downstream direction to cable modems that form DOCSIS endpoints (e.g., DOCSIS end points 58 of FIG. 2).

The fiber node identifier module 80 may identify the number of fiber nodes by deriving the number of fiber nodes from the CLI module 86. In an example embodiment, the fiber node identifier module 80 may thus in an automated fashion obtain the CLI configuration which reflects the customer's HFC topology. A fiber node may describe the physical topology which is unique to the MSO and geographical location.

An example fiber node configuration may be as follows:

```
  (config)# [no] cable fiber-node <fiber-node-id>
  (cable fiber-node)# [no] description <description>
  (cable fiber-node)# [no] downstream cable <slot>>/<subslot>/<unit>
  (cable fiber-node)# [no] downstream modular-cable
  <slot>/<subslot>/<unit> rf-channel <low-high> | <n>
Where,
  <fiber-node-id> is a numerical ID for the Fiber-Node
  <description> is a description of this Fiber-Node (optional)
  < low-high> are physical ports, for example, range 0 - 23 or 0 -17
  based on annex/modulation
  <n> is a physical port, for example,
        Range 0 - 23 or 0 -17 based on annex/modulation
        Represents one of the 24 RF channels/ports on a Blaze SPA
```

In an example embodiment, the channel identifier module 82 determines the radio frequency (RF) connector topology relating to channels to transmit or receive data over the number of fiber nodes. For example, the channel identifier module 82 may determine this RF connector topology by identifying a set of channels capable of transmitting or receiving data over each of the number of fiber nodes. The channel identifier module 82 may, for example, and referring back to FIG. 2, identify which RF channels are configured to transmit data over respective fiber nodes forming part of the HFC plant 54 in a downstream direction to the cable modems that form DOCSIS endpoints (e.g., DOCSIS endpoints 58 of FIG. 2).

In an example embodiment, the channel identifier module 82 may identify the set of channels by deriving the selection of channels from the CLI module 86. The channel association may be unique to the MSO configuration and may be configured by CLI.

The service group configuration module 84 derives the service groups, e.g., the downstream service groups, from the information identified by the fiber node identifier module 80 and the channel identifier module 82. In an example embodiment, the service group configuration module 82 may associate a service group with each identified selection of channels in respect of each of the number of fiber nodes. The service group configuration module 84 may further record the number of fiber nodes, the identified selection of channels and the associated service groups or sets in a service group table. In an example embodiment, this service group table may be stored in the memory 88.

The information recorded in the service group table, an example of which is shown in FIG. 5, may further be used by the CMTS 12 to overlap several, smaller, MAC domains in order to create a large logical MAP domain which can be supported by the underlying infrastructure of the DOCSIS network. In an example embodiment, the service group is a MAC-DOMAIN Service Group comprising a plurality of downstream MAC domain service groups.

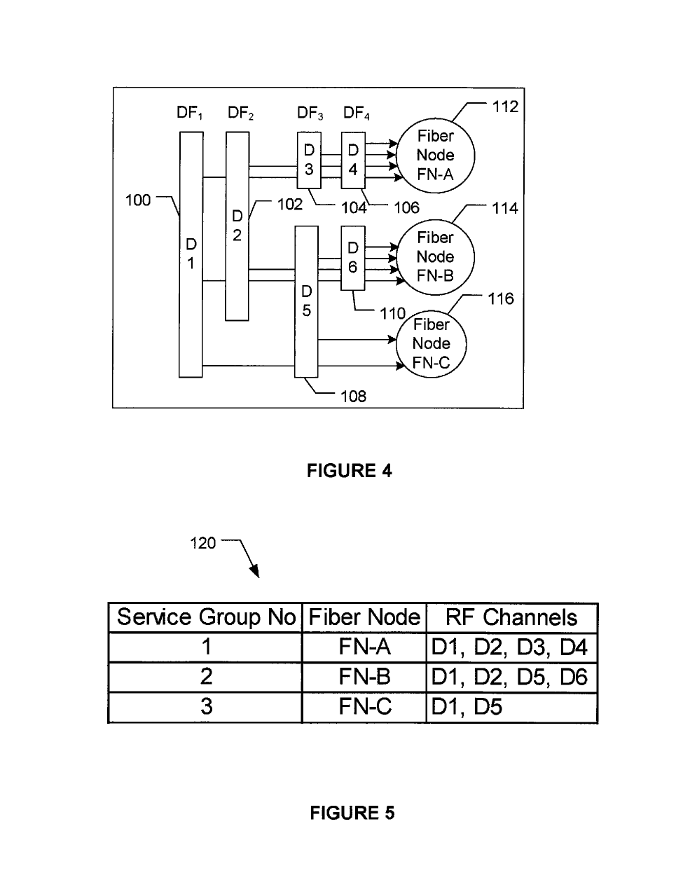

FIG. 4 shows an example of a frequency space diagram to indicate the configuration between downstream radio frequency (RF) channels and fiber nodes. In FIG. 4, the number of service groups are shown by way of example to equal the number of fiber nodes. A number of downstream channels D1 to D6, respectively depicted by reference numerals 100 to 110, are shown. Each downstream channel may transmit data to a fiber node at different frequencies. For example, each channel may have a bandwidth of 6 MHz. During channel bonding a number of these channels are combined to increase the overall bandwidth available, thereby to allow subscribers to receive a stream of packets from a high-speed network interface.

In the example embodiment shown in FIG. 4, the downstream channels may transmit data to three fiber nodes, namely fiber node A (FN-A) 112, fiber node B (FN-B) 114 and fiber node C (FN-C) 116. As is shown by this example embodiment, FN-A 112 is fed by downstream channels D1, D2, D3 and D4. FN-B 114 is similarly fed by downstream channels D1, D2, D5 and D6, while FN-C 116 is fed by downstream channels D1 and D5.

The fiber node identifier module 80 of FIG. 3 may, in an example embodiment, identify the fiber node topology by identifying that the CMTS is configured to communicate with three fiber nodes, namely FN-A 112, FN-B 114 and FN-C 116. The channel identifier module 82 may identify that, for example, D1 is a primary downstream channel and that FN-A 112 is fed by downstream channels D1 100, D2 102, D3 104 and D4 106, FN-B 114 is fed by downstream channels D1 100, D2 102, D5 108 and D6 110 and FN-C 116 is fed by downstream channels D1 100 and D5 108.

As described below, the service group configuration module 84 may then associate a first service group with channels D1, D2, D3 and D4, a second service group with channels D1, D2, D5 and D6 and a third service group with channels D1 and D5. This information may then be recorded in a service group table 120 as shown by FIG. 5, and maintained in the memory of the CMTS 12 for use during further configuration of the CMTS 12 and the cable network 10. In example the configuration shown in FIG. 4 the service groups correspond to the fiber nodes.

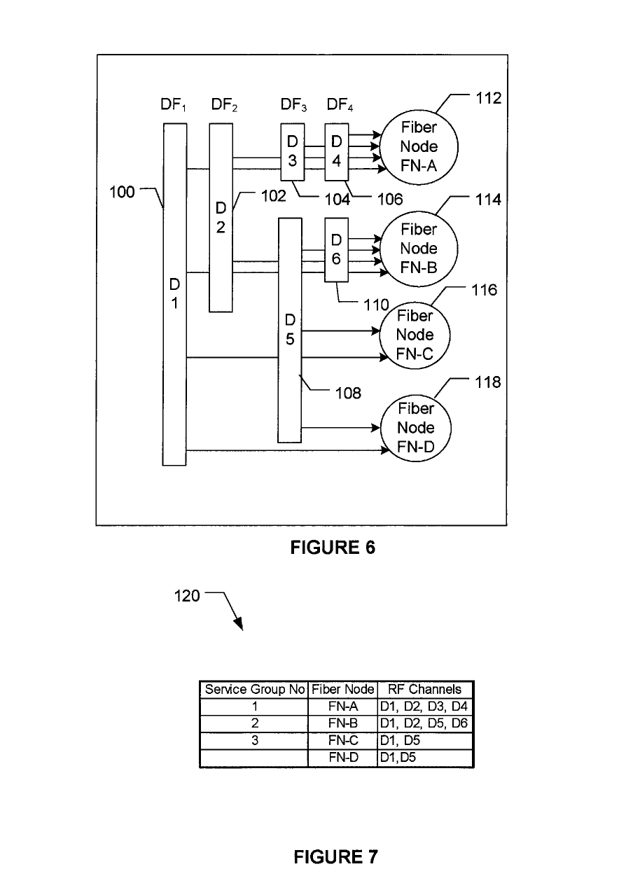

In FIG. 6, a further fiber node 118 is shown to be added to illustrate an example where the number of fiber nodes does not correspond to the number of service groups. The downstream channels now transmit data to four fiber nodes, namely FN-A 112, FN-B 114, FN-C 116, and FN-D 118. As is shown by this example embodiment, both FN-C 116 and FN-D 118 are fed by downstream channels D1 and D5. The service group configuration module 84 may then associate FN-C 116 and FN-D 118 with the same service group. As described below with reference to the method 140, duplicate sets of downstream channels may be eliminated when selecting MAC Domain service groups

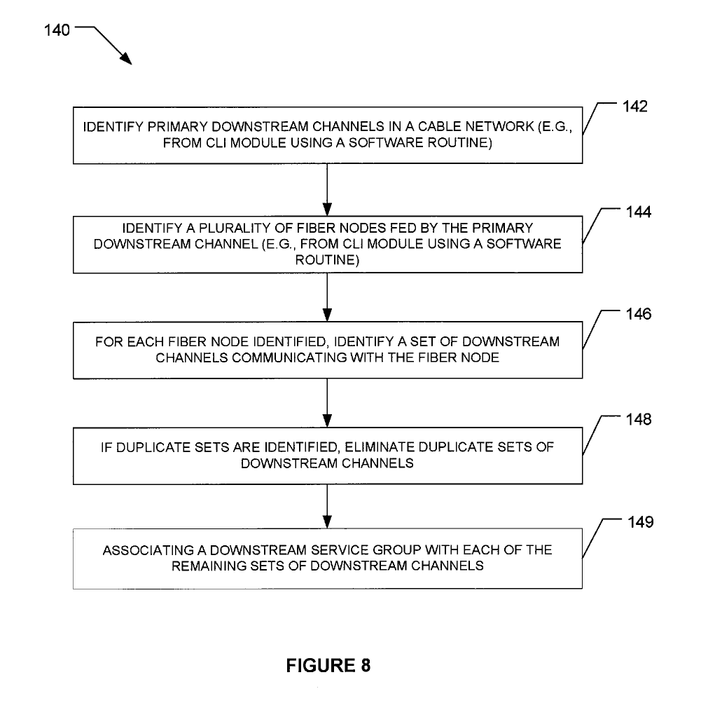

FIG. 8 shows an example of a method 140, in accordance with an example embodiment, for configuring service groups in a cable network. In an example embodiment, the method 140 may be implemented by the apparatus described with reference to FIG. 3 and be deployed in the system of FIG. 1.

As shown by block 142, a fiber node identifier module 80 may automatically identify primary downstream channels in the cable network such as a DOCSIS 3.0 network. In an example embodiment, the fiber node identifier module 80 includes software which, when executed, identifies the primary downstream channels by accessing a CLI module 88. For example, the method 140 may parse topology data in the CLI to identify a downstream channel with a “5/0/0”or “6/0/0”descriptor. A primary channels is a downstream channel from which a CM derives CMTS master clock timing for upstream transmission. In the example pseudo code above the primary channels are downstream Cable 5/0/0 and downstream Cable 6/0/0 channels. Thus, in an example embodiment a slot, subslot and unit of the downstream cable definition may be automatically investigated to identify primary capable downstream channels.

A channel identifier module 82 may identify a plurality of fiber nodes fed by the identified primary downstream channel as shown in block 144. In an example embodiment, the channel identifier module 82 may identify one or more primary downstream channels by accessing the CLI module 88 and deriving the plurality of channels from the CLI module 88.

As shown at block 146, for each fiber node identified, a set of downstream channels communicating with the fiber node is identified (see FIG. 7). If one or duplicate sets are identified (e.g., FN-C and FN-D in FIG. 7), the duplicate sets are eliminated (e.g., the set D1, D5 associated with FN-D may be eliminated). Thereafter, as shown at block 149, a downstream service group is associated with each of the remaining sets of downstream channels. In an example embodiment, a single MAC domain is associated with the remaining service groups.

By automatically discovering aspects the cable plant topology, as described above, less manual configuration of the parameters of a DOCSIS cable network is necessary, which may facilitate configuration of the network and may result in a reduction in the configuration errors by the Mobile Switching Office.

Returning to the example fiber node configuration shown in FIG. 7, the pseudo code for the configuration at the CLI may be as follows:

```
cable fiber 1
    description Fiber-Node-A
    downstream DF1
    downstream DF2
    downstream DF3
    downstream DF4
cable fiber 2
    description Fiber-Node-B
    downstream DF1
    downstream DF2
    downstream DF5
    downstream DF6
cable fiber 3
    description Fiber-Node-C
    downstream DF1
    downstream DF5
cable fiber 4
    description Fiber-Node-D
    downstream DF1
    downstream DF5
```

The corresponding downstream channel configuration automatically derived from the CLI may be as follows:

```
interface DF1
    primary-channel enable
    frequency 699MHz
interface DF2
    primary-channel disable
    frequency 705MHz
interface DF3
    primary-channel disable
    frequency 711MHz
interface DF4
    primary-channel disable
    frequency 717MHz
interface DF5
    primary-channel disable
    frequency 723MHz
interface DF6
    primary-channel disable
    frequency 729MHz
```

The following is a further example of commands that may be incorporated in the fiber node identifier module 80 and the channel identifier module 82 in order to identify the fiber nodes and the channels that may transmit to the respective fiber nodes.

```
#conf t
#cable fiber-node <1>
  description Branch office 41 located in Sunnyvale, CA 94086
  downstream Cable 5/0/0
  downstream Cable 6/0/0
  downstream Modular-Cable 1/0/0 rf-channel 0
  downstream Modular-Cable 1/0/0 rf-channel 1
#controller Wideband-Cable 1/0/0
  annex B modulation 64qam 0 23
  ip-address 1.9.1.1
  modular-host subslot 7/0
  rf-channel 0 frequency 699000000
  rf-channel 0 ip-address 192.168.200.31 mac-address 0090.f000.eaa8
udp-port 49152
  rf-channel 0 cable downstream channel-id <21> // new CLI
  rf-channel 1 frequency 705000000
  rf-channel 1 ip-address 192.168.200.31 mac-address 0090.f000.eaa8
udp-port 49153
  rf-channel 1 cable downstream channel-id <22> // new CLI
#interface Wideband-Cable 1/0/0:0
  cable rf-channel 0
  cable rf-cahnnel 1
```

In the above example, “#cable fiber-node<1> may identify FN-A 112, FN-B 114, and FN-C 116 in FIG. 4. The descriptor “downstream Cable 5/0/0” may then correspond to channel D1 100, and “downstream Cable 6/0/0” may then correspond to channel D2 102, “downstream Modular-Cable 1/0/0 rf-channel 0” may then correspond to channel D3 104, and “downstream Modular-Cable 1/0/0 rf-channel 1” may then correspond to channel D4 106 (see row 1 identifying service group 1 in FIG. 5. In an example embodiment, the methodology described herein identifies if the same frequency has been assigned to the same fiber node.

In an example embodiment, in order to identify duplicate sets of downstream channels in which two or more different fiber nodes are fed by the same downstream channels (e.g., see FN-C and FN-D in FIG. 7), a bitmap of each set of downstream channels for an associated fiber node is determined. Accordingly, a comparison of the bitmaps will identify duplicate sets. For example, assuming a 6 bit bitmap and the fiber node topology shown in FIG. 6, the bit map for FN-A 112 may be “111100” where the first bit (going from left to right) identifies channel D1 100, the second bit identifies channel D2 102, the third bit identifies channel D3 104, and the fourth bit identifies channel D4 106. As channels D5 108 and D6 110 are not associated with FN-A 112, the fifth and sixth bits are shown to be “0”. Thus, the bitmaps may be used to identify which channels are associated with a particular fiber node. Continuing the example, FN-B 114 may have a bitmap “110011” identifying that channels D1 100, D2, 102, D5 108, and D6 110 are associated with FN-B 114. FN-C 116 and FN-D may have bitmaps “100010”. In an example embodiment a bitmap of 64 bits is used to accommodate a large number of fiber nodes.

Thus, in an example embodiment, a bitmap for each fiber node may be determined. Thereafter, duplicate bitmaps are identified and identical sets of downstream channels may be automatically eliminated. In the example shown in FIG. 6, as FN-C 116 and FN-D 118 have the same bitmaps, one of them is eliminated (see block 148 in FIG. 8). Thus, the determination of the service group may be extracted from the fiber node topology in an automated fashion using software.

In an example embodiment, the method 140 (see FIG. 8) identifies one or more primary downstream channels from the CLI topology and automatically generates service groups from this data. A MAC domain corresponding to the MAC domain service groups identified by the method 140 and then selected as the MAC domain. An MDD message broadcast may then be initiated to a plurality of cable modems (e.g., the cable modems CM1 22.1, CM2 22.2 and CM 22.3 shown in FIG. 1) to provide information to the cable modems regarding their associated service groups.

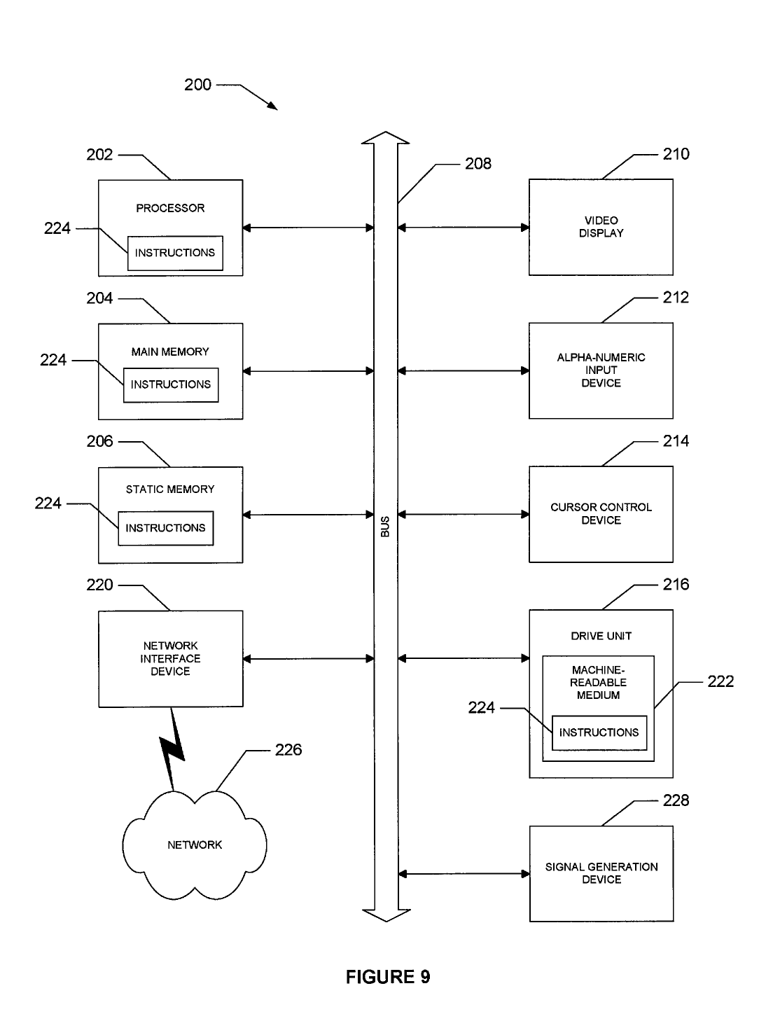

FIG. 9 shows a diagrammatic representation of machine in the example form of a computer system 200 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 200 includes a processor 202 (e.g., a central processing unit (CPU), a graphics processing unit (GPU) or both), a main memory 204 and a static memory 206, which communicate with each other via a bus 208. The computer system 200 may further include a video display unit 210 (e.g., a plasma display, a liquid crystal display (LCD) or a cathode ray tube (CRT)). The computer system 200 also includes an alphanumeric input device 212 (e.g., a keyboard), a user interface (UI) navigation device 214 (e.g., a mouse), a disk drive unit 216, a signal generation device 218 (e.g., a speaker) and a network interface device 220.

The disk drive unit 216 includes a machine-readable medium 222 on which is stored one or more sets of instructions and data structures (e.g., software 224) embodying or utilized by any one or more of the methodologies or functions described herein. The software 224 may also reside, completely or at least partially, within the main memory 204 and/or within the processor 202 during execution thereof by the computer system 200, the main memory 204 and the processor 202 also constituting machine-readable media.

The software 224 may further be transmitted or received over a network 226 via the network interface device 220 utilizing any one of a number of well-known transfer protocols (e.g., HTTP).

While the machine-readable medium 222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present application, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method comprising:
identifying a primary downstream channel in a cable network;
identifying a plurality of fiber nodes fed by the primary downstream channel;
for each fiber node identified, identifying a set of downstream channels communicating with the fiber node;
if duplicate sets are identified, eliminating duplicate sets of downstream channels; and
associating a downstream service group with each of the remaining sets of downstream channels.

2. The method of claim 1, comprising automatically selecting at least one Media Access Control (MAC) domain to correspond to the identified downstream service groups.

3. The method of claim 1, wherein the primary downstream channel is a Data Over Cable Service Interface Specification (DOCSIS) primary channel that carries synchronization signals for upstream channels.

4. The method of claim 1, comprising automatically selecting a MAC domain based on the primary downstream channel.

5. The method of claim 1, comprising:
accessing Command Line Interface (CLI) data to obtain a fiber node topology of the cable network; and
identifying the primary downstream channel from the fiber node topology.

6. The method of claim 1, comprising automatically generating an MDD message broadcast to a plurality of cable modems to identify the downstream service groups.

7. The method of claim 1, wherein identifying the primary downstream channel comprises automatically inspecting network topology data to identify a downstream channel with a “5/0/0” or “6/0/0” description.

8. The method of claim 1, wherein eliminating duplicate sets of downstream channels comprises:
for each fiber node identified, generating a bit map identifying the set of downstream channels communicating with the fiber node; and
comparing bit maps of the fiber nodes to identify the duplicate sets.

9. An apparatus comprising:
a channel identifier module configured to identify a primary downstream channel in a cable network;
a fiber node identifier module configured to identify a plurality of fiber nodes fed by the primary downstream channel; and
a service group configuration module configured to:
for each fiber node identified, identify a set of downstream channels capable of communicating with the fiber node;
if duplicate sets are identified, eliminate duplicate sets of downstream channels; and
associate a downstream service group with each of the remaining sets of downstream channels.

10. The apparatus of claim 9, wherein the service group configuration module is configured to automatically select at least one Media Access Control (MAC) domain to correspond to the identified downstream service groups.

11. The apparatus of claim 9, wherein the primary downstream channel is a DOCSIS primary channel that carries synchronization signals for upstream channels.

12. The apparatus of claim 9, wherein the service group configuration module is configured to automatically select a MAC domain based on the primary downstream channel.

13. The apparatus of claim 9, wherein:
the fiber node identifier module is configured to access Command Line Interface (CLI) data to obtain a fiber node topology of the cable network; and
the service group configuration module is configured to identify the primary downstream channel from the fiber node topology.

14. The apparatus of claim 9, wherein a CMTS is configured to communicate an MDD message broadcast to a plurality of cable modems to identify the downstream service groups.

15. The apparatus of claim 9, wherein identifying a primary downstream channel comprises automatically inspecting network topology data to identify a downstream channel with a “5/0/0” or “6/0/0” description.

16. The apparatus of claim 9, wherein the service group configuration module is configured to:
for each fiber node identified, generate a bitmap identifying the set of downstream channels communicating with the fiber node; and
compare bit maps of the fiber nodes to identify the duplicate sets.

17. A machine-readable medium embodying instructions that, when executed by a machine, cause the machine to:
identify a primary downstream channel in a cable network;
identify a plurality of fiber nodes fed by the primary downstream channel;
for each fiber node identified, identify a set of downstream channels communicating with the fiber node;
if duplicate sets are identified, eliminate duplicate sets of downstream channels; and
associate a downstream service group with each of the remaining sets of downstream channels.

18. The machine-readable medium of claim 17, wherein the instructions cause the machine to select at least one Media Access Control (MAC) domain corresponding to the identified service groups.

19. The machine-readable medium of claim 17, wherein the instructions cause the machine to select a MAC domain based on the identified primary downstream channel.

20. The machine-readable medium of claim 17, wherein the instructions cause the machine to access Command Line Interface (CLI) data to obtain a fiber node topology of the cable network, and identify the at least one primary downstream channel from the fiber node topology.

21. Apparatus comprising:
means for identifying a primary downstream channel in a cable network;
means for identifying a plurality of fiber nodes fed by the primary downstream channel;
means for identifying, for each fiber node identified, a set of downstream channels communicating with the fiber node;
means for if duplicate sets are identified, eliminating duplicate sets of downstream channels; and
means for associating a downstream service group with each of the remaining sets of downstream channels.
